(19) United States
(12) Patent Application Publication
(10) Pub. No.: US 2024/0326484 A1
(43) Pub. Date: Oct. 3, 2024

(54) Media Cartridge Having Media Roll Locking Mechanism

(71) Applicant: ZEBRA TECHNOLOGIES CORPORATION, Lincolnshire, IL (US)

(72) Inventors: Raymond E. Maynard, Westerly, RI (US); Morgan Hassan Malone, Swansea, MA (US)

(21) Appl. No.: 18/129,496

(22) Filed: Mar. 31, 2023

(51) Int. Cl. B41J 15/04; B41J 2/315

(52) U.S. Cl. CPC B41J 15/044; B41J 2/315

(57) ABSTRACT

An example disclosed herein includes a media cartridge. The media cartridge includes a housing. The media cartridge further includes a media core supported within the housing where the media core includes at least one detent arranged radially around an inner surface of the media core. The media cartridge includes a locking tab having a cam and at least one tooth. The locking tab being movable between a default position and a flexed position. When the locking tab is in the default position, the at least one tooth is engaged with the at least one detent and in the flexed position, the cam is compressed inwardly causing the at least one tooth to disengage from the at least one detent of the media core.

### BACKGROUND OF THE INVENTION

Media processing devices, namely printers or other systems, can process media from a media cartridge. The media contained within the media cartridge can include wristbands, labels, receipt media, cards, and the like. The manner in which the media is stored in the media cartridge can be important to proper functionality of the media processing device.

### BRIEF DESCRIPTION OF THE SEVERAL VIEWS OF THE DRAWING(S)

FIG. 1 illustrates a perspective view of a media processing device containing a media cartridge according to example embodiments of the present disclosure;

FIG. 2 illustrates a perspective view of the media cartridge illustrated in FIG. 1 according to an example embodiment of the present disclosure;

FIG. 3 illustrates another view of the media cartridge of FIG. 2 with a wall section removed for clarity according to an example embodiment of the present disclosure;

FIG. 4 illustrates an enhanced view of a side wall section as illustrated in FIG. 2 according to an example embodiment of the present disclosure;

FIG. 5 illustrates an alternative view of a side wall section as illustrated in FIG. 2 according to an example embodiment of the present disclosure; and

FIG. 6 illustrates a cross-sectional view of the media cartridge as illustrated in FIG. 2 according to an example embodiment of the present disclosure.

FIG. 7 illustrates an alternative cross-sectional view of the media cartridge as illustrated in FIG. 2 according to an example embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Embodiments of the present disclosure now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

There have been issues with the manufacture and assembly of media cartridges that can negatively impact the operation of media processing devices. Media processing devices (also referred herein as “printers”) may be configured to print and/or encode media drawn from a media roll or media spool contained in a media cartridge (also referred herein as “cartridge”). In some cases, the media cartridges holding the media roll does not fully secure the media roll within the media cartridge, which allows the media within the media roll to lose tension, slacken or loosen during shipping.

In most cases, it is necessary that the media roll within the media cartridge maintains tension around a media core at the center of the media roll. If the tension is not maintained on the media roll, slack develops within the tension of the media on the media roll which causes issues within the cartridge during printing or media processing operations. Such issues may include jamming, skewed media during printing, media being driving past a print head uniformly, or other similar issues known in the art. Particular types of media, such as a roll of wristbands, are especially prone to slack issues given their longer dimensions.

Issues that arise in attempting to maintain tension in a media cartridge concerns the modularity of the cartridge. As the cartridges may be shipped individually or within the printer, any system to maintain tension of the media roll within the cartridge must be able to work both inside and outside the printer. Also, as the printer needs to be able to drive media from the media roll within the printer, it is important that the tension system of the cartridge as engaged while outside the printer is disengaged when the cartridge is inserted into the printer. This will allow the printer to have control of the media roll in driving media from the cartridge and printing on said media.

Therefore, it is desired to have a way to maintain the tension of the media roll within the media cartridge. It is also desired to have a simplified design with a reduction of parts to aid in reduction of manufacturing cost and time.

Embodiments of the present disclosure advantageously reduce a number of discrete parts used to assemble a convention media cartridge and/or can be reduced and the amount of time required to assemble media cartridges, while also ensuring that the media cartridge maintains tension of the media roll within the media cartridge.

Embodiments of the present disclosure provide for a media cartridge that includes a housing; a media core supported within the housing, the media core including at least one detent arranged radially around an inner surface of the media core; a locking tab having at least one tooth engaged with the at least one detent; and a cam disposed on the locking tab opposite the at least one tooth; wherein when the cam is compressed inwardly, the at least one tooth disengages from the detents of the media core.

Embodiments of the present disclosure provide for a media cartridge that includes a housing, a media core, and a locking tab. The media core is supported within the housing and includes at least one detent arranged radially around an inner surface of the media core. The locking tab has a cam and at least one tooth and is movable between a default position and a flexed position. In the default position, the at least one tooth is engaged with the at least one detent. In the flexed position, the cam is compressed inwardly causing the at least one tooth to disengage from the at least one detent of the media core.

Embodiments of the present disclosure provide for a printer a printer housing; and a slot in the printer housing configured to receive a media cartridge, the media cartridge having a locking tab engages with a media core, the media core having at least one detent; wherein: when the media cartridge is inserted into the slot, the slot applies a force to the locking tab, the force causing rotation of the locking tab in a first direction away from the detent of the media core causing the locking tab to disengage with the media core, and when the media cartridge is removed from the slot, the force is removed from the locking tab, causing the locking tab to rotate in a second direction opposite the first direction, allowing the locking tab to engage with the detent of the media core.

Embodiments of the present disclosure provide for a method of forming a media cartridge. The method includes receiving a media roll in a cartridge housing. The media roll includes a tubular media core and media wound about the tubular media core. The tubular media core is positioned on a spindle of the cartridge housing. The tubular media core includes at least one detent disposed on an inner surface of the tubular media core. The method also includes positioning at least one tooth of a locking tab relative to the at least one detent of the media core. The locking tab extends from a flexible strip formed on a wall of the cartridge housing. The method further includes moving the locking tab between a default position in which the at least one tooth is engaged with the at least one detent to prevent rotation of the media core relative to the cartridge housing and a flexed position in which the locking tab rotates, via flexing of the strip, to disengage the at least one tooth from the at least one detent of the media core and to allow the media core to rotate relative to the cartridge housing.

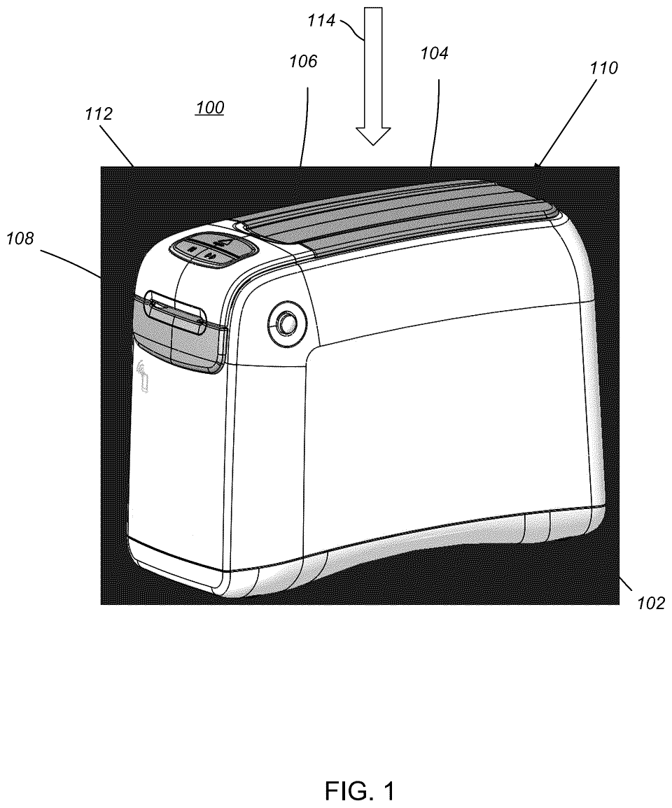

FIG. 1 illustrates a printer or media processing device 100 according to example embodiments of the present disclosure. While the illustrated embodiments and description provided herein are directed primarily to a printing device, other media processing devices such as media encoders, label applicators, or laminators, may benefit from the mechanisms described. The depicted embodiment is of a direct thermal printer, however one skilled in the art would appreciate that other types of thermal printers may be used.

The printer 100 includes a housing 102. According to the illustrated embodiment, the housing 102 includes a slot 106 which is configured to receive a cartridge 104. The cartridge 104 is described further below. The slot 106 is depicted on a top side 110 of the printer 100, however in other embodiments, the slot 106 is featured on a side of the printer 100.

The printer 100 features a media output 108. The media output 108 is positioned downstream from a printhead and/or encoder, wherein the printhead and/or encoder is configured to process media received from the cartridge 104. In the illustrated embodiment, the printhead is positioned within the printer and is a thermal printhead. The printhead is located adjacent to a platen, wherein the platen is configured to drive media past the printhead for processing. The platen may also operate to reverse media back into the printer if necessary.

The printer 100 further includes a user interface 112, which can include, for example, one or more operation buttons 114. In the depicted embodiment, the operation buttons 114 include a cartridge eject button, a pause button, and a feed button. It is appreciated that in other embodiments of the printer 100, the user interface 112 may include other or different components and/or that other types of operation buttons 114 may be present. The cartridge eject button is operational to eject the cartridge 104 from the slot 106. The pause button is operational to stop the printer from printing.

As illustrated in FIG. 1, the cartridge 104 is inserted into the printer 100 in a first direction 114. While the first direction 114 as depicted is pointed in a downward direction, it should be appreciated that the first direction 114 is dependent on the alignment of the slot 106 of the printer 100, as the cartridge 104 enters into the slot 106.

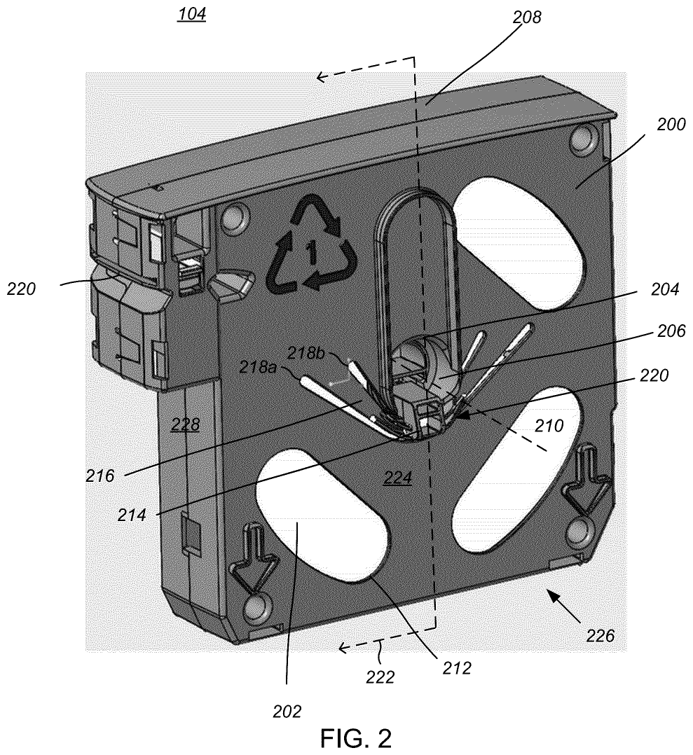

FIGS. 2-6 illustrate a media cartridge 104, or cartridge in accordance with embodiments of the present disclosure. Referring to FIG. 2, the media cartridge 104 includes a cartridge housing 200 that is configured to hold a media roll 202. The cartridge housing 200 includes a top wall 208, a bottom wall 226, major side walls 224, and minor side walls 228 that enclose and/or retain the media roll 202 within the cartridge housing 200. The top wall 208, bottom wall 226, and minor side walls 228 can be disposed about a circumference (or cylindrical surface) of the media roll 202, while the major side walls 224 can be opposing disposed from each other extending between top wall 208, bottom wall 226, and minor side walls 228 (e.g., adjacent to an edge of the media in the media roll 202 or a base surface form the by the edge of the media in the media roll 202). The media roll 202 can be concentric with an aperture 204 in the main side walls 224. The aperture 204 may lead to an internal side wall 206. At lease one of the side wall surfaces 224 can include an aperture 212 through which the media roll 212 within the housing 200 is visible.

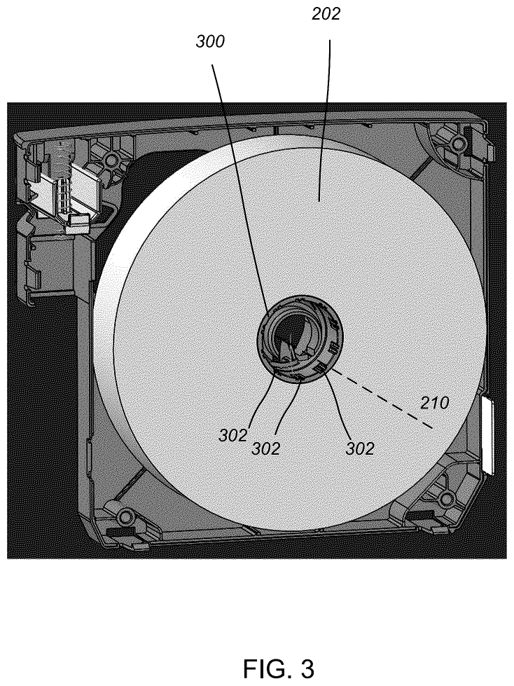

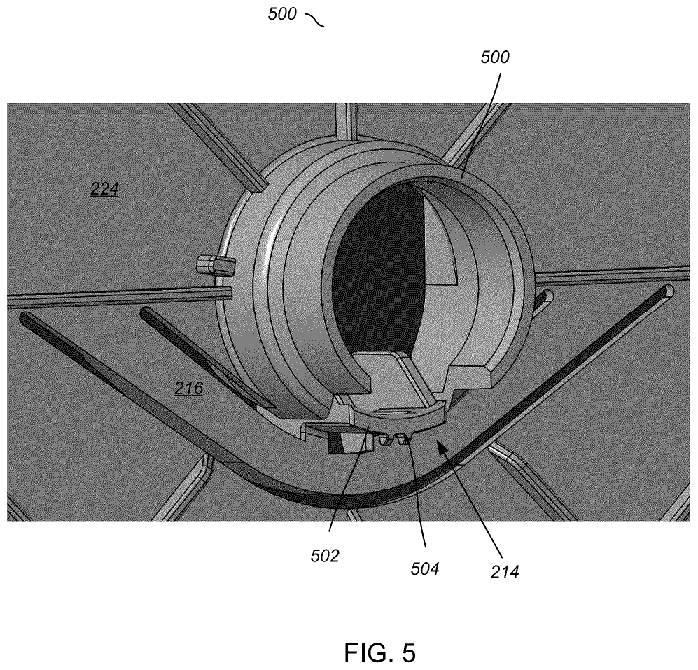

As shown in FIGS. 2-3, the media roll 202 is supported by a media core 300. One of the side walls 224 has been removed from the media housing 200 in FIG. 3 to show an interior of the media housing 200. In the depicted embodiment, the media roll 202 can be formed by wristbands attached end to end, separated by a perforated edge. In other embodiments, the media roll 202 can feature a web of labels, a 2-ply form where wristbands can be removed, liner-less labels, or any type of printable material that can be stored in a roll. The media is wrapped tightly around the media core 300, which can have a tubular structure having a central axis along core axis 210. The media core 300 can be supported by a spindle 500 (FIG. 5) of media cartridge 104. In the depicted embodiment, the media core 300 features detents 302. In other embodiments, there may be one or more detents 302. As an example, the media core can include several detents such that the media core 300 is ribbed around an inner perimeter of the media core 300. As depicted, the detents 302 are equally spaced radially around the inner perimeter of the media core 300, however it is appreciated that the detents 302 may be distributed in any spacing or configuration.

Referring to FIGS. 2 and 5, the cartridge 104 further includes a locking tab 220. The locking tab 220 can include a cam 214 and teeth 504. The locking tab 220 is located on one of the major side wall surfaces 224 of the cartridge 104. Another locking tab can be located on the other one of the major side wall surfaces. A portion of the locking tab 220 (e.g., outside edge 602 of the cam 214) can protrude outwardly from its corresponding major side wall surface 224 such that it is external to the housing 200 and a portion of the locking tab 220 (e.g., a portion of the cam 214 including the teeth 504) can extend inwardly from its corresponding major side wall surface 224 such that it is internal to the housing 200. For example, the locking tab 220 is integrally formed with the major side walls 224 of the cartridge 104 and each one of the side walls and corresponding locking tab 220 can be molded during production as one integral component. In other embodiments the locking tab 220 is a modular piece that is securely attached to the major side walls 224 during assembly of the media cartridge 104. As described herein, the teeth of the locking tab 220 can selectively engage at least some of the detents 302 of the media core 300 to prevent rotation of the media core relative to the cartridge housing 200.

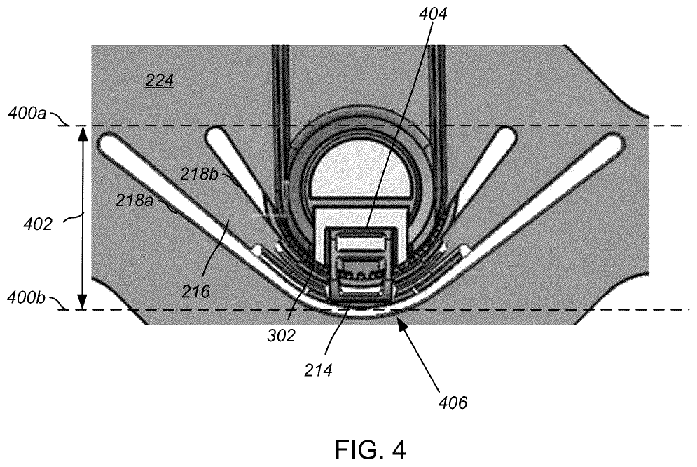

The locking tab 220 is located on flexible strip 216 (hereinafter strip 216). The strip 216 is formed by the side wall 224 of the housing 200 due to the presence of a first cutout 218a and a second cutout 218b (collectively “cutouts 218”) in the side wall(s) 224. The cutouts 218a-b are apertures in the side wall(s) 224 of the housing 200 and are shaped to allow strip 216 to flex or pivot respective to and independent of the remaining housing 200. The cutouts 218 and the strip 216 is shown in further detail in FIG. 4.

As will be described in further detail below, in the depicted embodiments, the locking tab 220 can move between a default (original) or locked position in which the teeth 504 engage the detents 302 and a flexed or unlocked position in which the teeth 504 are displaced away and disengaged from the detents 302. The locking tab 220 is rigidly secured to the strip 216 such that a force exerted on to the locking tab 220 can cause the strip 216 to flex or pivot. For example, when the cartridge 104 is inserted into the slot of the printer 100, the cam 214 section of the locking tab 220 comes into contact with inner walls of the slot 106. The contact between the walls of the slot 106 and the cam 214 can urge the cam 214 inward towards the housing 200 causing the locking tab 220 and the strip 216 to be flexed inwards towards the media core of the cartridge 104. As the strip 216 is flexed inward, the locking tab 220 rotates outward away from the media core 300 to transition from the default position to the flexed position and teeth 504 of the locking tab 220 are disengaged from the detents 302 of the media core 300. When the teeth 504 are disengaged from the detents 302 of the media core 300, the media core 300 and the media roll 202 are unlocked allowing the media core 300 and media roll 202 to rotate relative to the cartridge housing 200 such that the media is able to be unwound from the media roll 202 by the printer 100. As the cartridge 104 is removed from the slot 106, the force exerted onto the cam 214 ceases and the cam 214 releases from the inner wall of the slot 106 such that the strip 216 and the cam 214 are free to flex back to their default (original) position relative to the side wall(s) 224 of the housing 200. As the strip 216 flexes back to the default (original) position, the cam teeth 504 re-engage with the detents 302 of the media core 300 and prevent rotation of the media core 300 within the cartridge 104 outside of the printer 100.

FIG. 4 depicts an enhanced view of one of the major side walls 224 of the housing 200. FIG. 4 further depicts the relationship between the strip 216 and the cutouts 218a-b. Dotted line 400a denotes an upper limit of the strip 216 and dotted line 400b denotes a lower limit of the strip 216. The strip 216 formed from the cutouts 218a and 218b can be curved. For example, a first edge of the strip formed by cutout 218a and a second edge of the strip 216 formed by cutout 218b can have curved portions formed radially about the center axis of the media core 300 and generally concentrically positioned relative to the media core 300. The first and second edges of the strip can have linear portions extending from each end of the curved portions. The curved portions can have different curvatures such that the curvature of the curved portion of the first edge of the strip is less than the curvature of the second edge of the strip 216 (or the radius of curvature of the first edge is greater than the radius of curvature of the second edge). The distance between the first and second edges of the strip can increase from a midline of the strip towards the ends of the strip, although in some embodiments, the distance between the first and second edges can be generally uniform. The distance 402 between the upper limit 400a and the lower limit 400b represents the height of the strip 216. The distance 402 is directly related to the distance that the strip 216 is able to flex. In other words, the greater the distance 402, the further the bottom of the strip 216 can flex relative the side wall 224. In some embodiments, the major side wall 224 can be a planar structure and the strip 216 formed by the cutouts 218a-b in the sidewalls 224 can be coplanar with the remainder of the side wall 224 in its default (original) position, where “flexing” in such embodiments refers to the bending of the strip 216 out of a plane formed by the side wall 224 of the housing 200. As depicted in FIG. 4, if the strip 216 is flexed, it is done so into and out of FIG. 4 as it is viewed. In other words, the strip 216 can begin in the plane even with the side wall 224 of the housing 200 and as a force is applied to the cam 214, the strip 216 is able to flex away from the plane of the side wall 224. It is important to note that the housing 200, the side wall 224, and the strip 216 are all composed of a material that is resilient and capable of flexing as necessary and returning to its original position.

As depicted in FIG. 4, the cutouts 218 are optimized through multiple iterations of finite element analysis. The cutouts 218 establish a geometry for the strip 216 of the cam that created sufficient force to engage the tooth/teeth with the core to prevent rotation while maintaining a low enough stress through the arm of the cam to prevent permanent deformation should the cartridge be left in the printer and the cam left in the deflected position for an indefinite period (stress below the creep limit of the plastic).

As depicted in FIG. 4, the cam 214 is attached to a bottom 406 of the strip 216. In the depicted embodiment, the cam 214 has a cam top surface 404 which is flat (seen in profile in FIG. 4.) In other embodiments, the cam 214 may have a different shape. As the cam 214 is secured to the strip 216, the flexing of the strip 216 causes the cam 214 to rotate.

FIG. 5 illustrates an opposite view of the cam 214 from the inside of the cartridge 104. The media roll 202 has been removed from the view shown in FIG. 5 for clarity's sake. In the absence of the media roll, the spindle 500 can be seen. During standard operation, the spindle 500 is configured to rotatable support the media core, wherein the spindle 500 fits inside the media core when the cartridge 104 is assembled.

In the illustrated embodiment, the strip 216 is arced in a cam 214 is positioned such that an arced surface 502 of the cam 214 is aligned with a wall of the spindle such that the arced surface 502 of the cam 214 interacts with an inner surface of the media core. The cam 214 is shown positioned on the strip 216. As illustrated, the cam teeth 504 are positioned on and protrude from the arced surface 502 of cam 214. As depicted, an embodiment of the cam 214 can include two cam teeth 504. However, in other embodiments, the cam 214 may include one cam tooth or several cam teeth. As will be discussed further below, the cam teeth 504 are configured to engage with the detents 302 of the media roll 300. The teeth 504 project from the locking tab 220 in the first direction parallel to the insertion direction of the cartridge 104 into the slot 106 and/or project outward radially from the arced surface 502 of the locking tab in a direction that is perpendicular to an axis of rotation of the media core.

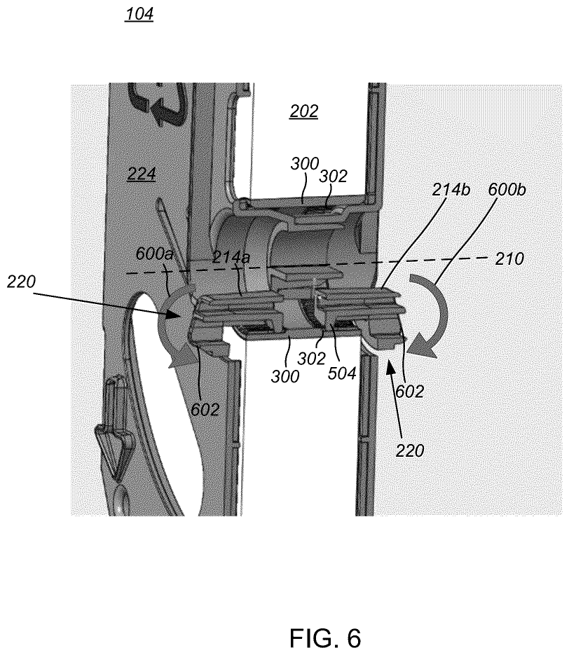

FIG. 6 illustrates a cross section of the cartridge 104 along the dotted line 222 of FIG. 2. The cross-sectional view of FIG. 6 shows a cross section of the media roll 202 including the media core 300. In the illustrated embodiment, the media core 300 includes detents 302 encircling the inner surface of the media core 300. The core axis 210 is shown in FIG. 6 with the media core 300 shown on each side of the core axis 210 as the media core 300 encircles the core axis 210. The locking tabs 220, depicted on each side of the cartridge 104, are both mounted on a respective strip 216 on each respective side of the cartridge 104.

As illustrated in FIG. 6, the cartridge 104 is not presented in a printer, which allows the locking tab 220 to be in its default (original) unflexed position such that the cam teeth 504 to engage with the detents 302 of the media core 300. The engagement between the cam teeth 504 and the detents 302 prevents the media roll 202 and the media core 300 from rotating freely within the cartridge 104.

When the cartridge 104 is inserted into the slot 106 of the printer 100 as shown in FIG. 1, the cams 214 (individually 214a and 214b) contact inner walls of the slot 106 which exert an inward force onto the cams 214 forcing the strips 216 to flex with the cams 214 of the locking tab 220 into the housing 200. The flexing inward of the strips 216 causes the respective cam 214 on each strip 216 to rotate in the direction indicated by arrows 600a and 600b (arrows 600 collectively). For the embodiment depicted in FIG. 6, the cam 214a rotates as shown by arrow 600a and the cam 214b rotates in an opposite direction as shown by arrow 600b.

In the depicted embodiment, the cams 214 are configured to rotate in the direction of arrow 600 due to the curvature of an outside cam surface 602 of the cams 214. The curvature of the outside cam surface 602 causes the inner walls of the slot to force the cam 214 inwards, which causes the rotation of the cam 214 upon the strip 216 as described above.

In the illustrated embodiment of FIG. 6, when the cams 214 rotate, it causes each respective set of cam teeth 504 to be lifted away and disengaged from the respective detents 302. The disengagement of the detents 302 by the respective cam teeth 504 allow the media roll 202 to rotate within the cartridge 104.

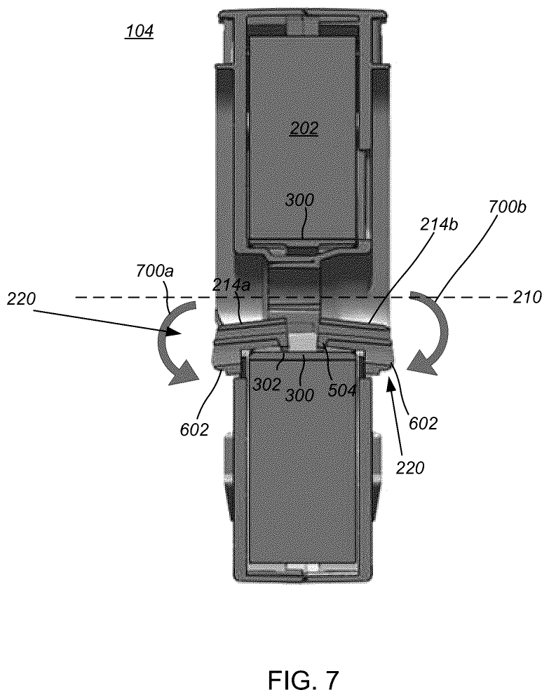

FIG. 7 illustrates a cross section view as in FIG. 6, however, FIG. 7 illustrates the cams 214 in a rotated position. In the illustrated embodiment of FIG. 7, the cams 214 are rotated in the direction shown by arrows 700a and 700b. When rotated into the position shown in FIG. 7, the cam teeth 504 are disengaged from the detents 302 and the media roll 202 is free to rotate within the cartridge 104.

Once the cartridge 104 is installed into the printer 100, the cam teeth 504 become disengaged from the detents 302 due to contact between the cam 214 and the slot wall. In the depicted illustration, the disengaging of the cam teeth 504 from the detents 302 allows the media roll 202 to freely rotate. However, once the cartridge 104 is inserted into the printer 100, the media from the media roll is captured by the printer such that the printer will prevent the media roll 202 from unwinding unless the printer 100 is drawing media from the media roll.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

That which is claimed:

1. A media cartridge comprising:
a housing;
a media core supported within the housing, the media core including at least one detent arranged radially around an inner surface of the media core;
a locking tab having a cam and at least one tooth, the locking tab being movable between a default position and a flexed position;
wherein in the default position, the at least one tooth is engaged with the at least one detent and in the flexed position, the cam is compressed inwardly causing the at least one tooth to disengage from the at least one detent of the media core.

2. The media cartridge of claim 1, wherein the housing comprising a side wall that includes a plurality of cutouts creating a strip positioned between the cutouts.

3. The media cartridge of claim 2, wherein the locking tab is disposed on the strip.

4. The media cartridge of claim 1, wherein the media core is unable to rotate relative to the housing when the tooth is engaged with the detent.

5. The media cartridge of claim 1, wherein the media core supports a media roll.

6. The media cartridge of claim 5, wherein the media roll comprises wristbands configured for thermal printing.

7. The media cartridge of claim 1, wherein the housing comprises opposing first and second side walls, the locking tab is positioned on the first side wall and a second locking tab is positioned on the second side wall such that the locking tab and the second locking tab are positioned opposite each other.

8. The media cartridge of claim 1, wherein the media core has a rotational axis that aligns with an aperture in the housing of the media cartridge.

9. The media cartridge of claim 1, wherein:
the at least one tooth projects from the locking tab in a direction that is perpendicular to an axis of rotation of the media core.

10. The media cartridge of claim 1, wherein the locking tab moves in a rotational direction to transition from the default position to the flexed position.

11. A printer comprising:
a printer housing; and
a slot in the printer housing configured to receive a media cartridge, the media cartridge having a locking tab, the media core having at least one detent;
wherein:
when the media cartridge is inserted into the slot, the slot forces the locking tab to rotate in a first direction away from the detent of the media core causing the locking tab to disengage with the media core, and
when the media cartridge is removed from the slot, the locking tab rotates in a second direction opposite the first direction, allowing the locking tab to engage with the detent of the media core.

12. The printer of claim 11, wherein the media core is unable to rotate within the media cartridge when the locking tab is engaged with the detent and the media core is free to rotate within the media cartridge when the locking tab is disengaged from the detent.

13. The printer of claim 11, wherein the media cartridge comprises a side wall which includes a plurality of cutouts creating a strip positioned between the cutouts.

14. The printer of claim 13, wherein the locking tab is disposed on the strip.

15. The printer of claim 11, wherein the locking tab comprises a cam and a tooth opposite the cam on the locking tab, wherein the tooth is configured to engage with the detent.

16. The printer of claim 11, wherein the printer is configured for direct thermal printing and the media cartridge includes a plurality of wristbands configured for thermal printing.

17. The printer of claim 11, wherein the media cartridge includes a second locking tab, the locking tab and the second locking tab are configured to contact opposite sides of the slot.

18. The printer of claim 11, wherein:
the media cartridge is inserted into the printer in a first direction; and
the locking tab includes teeth projecting in the first direction.

19. The printer of claim 11, wherein the media cartridge is inserted into the printer in a lateral direction, and the locking tab of the media cartridge moves in a rotational direction.

20. A method of forming a media cartridge, the method comprising:
receiving a media roll in a cartridge housing, the media roll including a tubular media core and media wound about the tubular media core, the tubular media core is positioned on a spindle of the cartridge housing, the tubular media core includes at least one detent disposed on an inner surface of the tubular media core;
positioning at least one tooth of a locking tab relative to the at least one detent of the media core, the locking tab extending from a flexible strip formed on a wall of the cartridge housing;
moving the locking tab between a default position in which the at least one tooth is engaged with the at least one detent to prevent rotation of the media core relative to the cartridge housing and a flexed position in which the locking tab rotates, via flexing of the strip, to disengage the at least one tooth from the at least one detent of the media core and to allow the media core to rotate relative to the cartridge housing.
